(19) United States
(12) Patent Application Publication
(10) Pub. No.: US 2013/0271442 A1
(43) Pub. Date: Oct. 17, 2013

(54) FLAT-PANEL DISPLAY INCLUDING MEMRISTIVE DEVICES

(71) Applicants: Wendi Li, Hong Kong (CN); Wei Yi, Mountain View, CA (US); Wei Wu, Palo Alto, CA (US); Jianhua Yang, Palo Alto, CA (US)

(72) Inventors: Wendi Li, Hong Kong (CN); Wei Yi, Mountain View, CA (US); Wei Wu, Palo Alto, CA (US); Jianhua Yang, Palo Alto, CA (US)

(21) Appl. No.: 13/445,995

(22) Filed: Apr. 13, 2012

(51) Int. Cl. G09G 3/36; G06F 3/038

(52) U.S. Cl. 345/212; 345/205; 345/87

(57) ABSTRACT

A flat-panel display system and method are disclosed. The system includes a display controller to generate image data. The system also includes a plurality of memristive pixel cells arranged in a plurality of rows and in a plurality of columns. Each of the plurality of memristive pixel cells includes a memristive device to control a respective pixel associated with the flat panel display based on the image data.

### BACKGROUND

The demand for consumer electronic devices that incorporate flat-panel displays is steadily increasing based on a desire for space savings and portability. Flat-panel displays are currently being used for a variety of consumer electronic devices, such as televisions, laptop and tablet computers, portable electronic reading devices, digital picture frames, price-labels, and a variety of other electronic devices. Typical flat-panel displays can implement thin film transistors (TFTs) that can incorporate silicon-based semiconductor materials. Such TFTs can require high temperature fabrication processes, can include complex structures, and can have limited response times.

### BRIEF DESCRIPTION OF THE DRAWINGS

FIG. 1 illustrates an example of a flat-panel display system.

FIG. 2 illustrates another example of a flat-panel display system.

FIG. 3 illustrates an example of a memristive pixel cell.

FIG. 4 illustrates an example method for generating an image on a flat-panel display.

### DETAILED DESCRIPTION

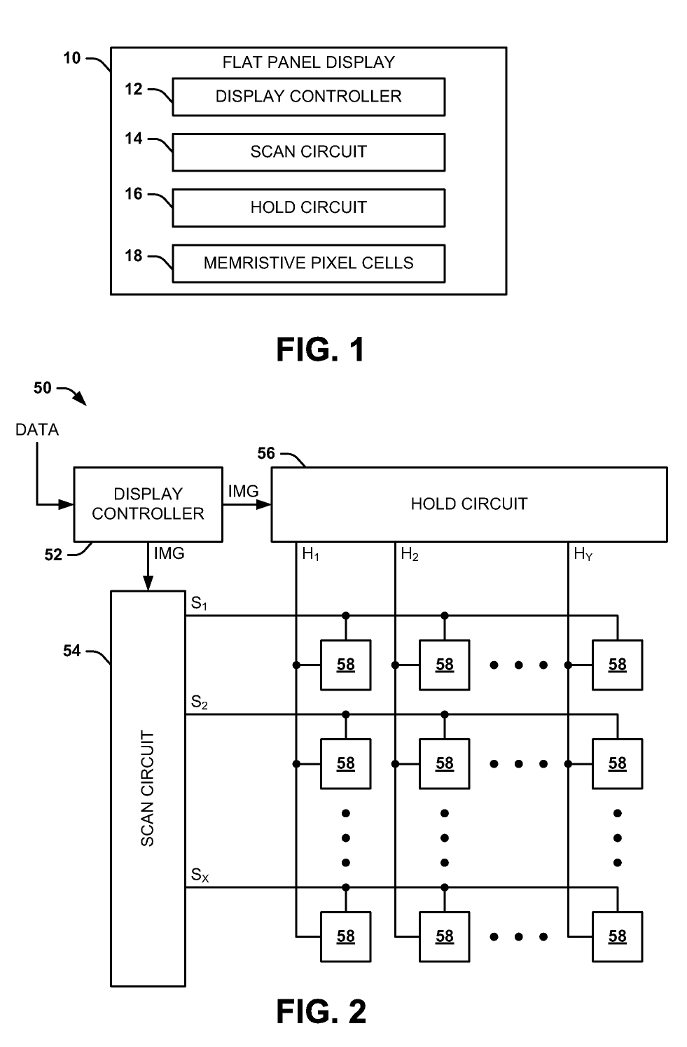

FIG. 1 illustrates an example of a flat-panel display system 10. The flat-panel display system 10 can be incorporated in a display device of a variety of consumer electronic products, such as televisions, laptop and tablet computers, portable electronic reading devices, digital picture frames, price-labels, flexible display devices, and a variety of other electronic devices. As disclosed herein, the flat panel display can employ a variety of display technologies.

In the example of FIG. 1, the flat-panel display system 10 includes a display controller 12. The display controller 12 is configured to generate image data, such as in response to a processor (not shown). The display controller 12 can be configured to provide the image data to a scan circuit 14 and a hold circuit 16. The scan and hold circuits 14 and 16 can correspond to peripheral circuitry for activating and deactivating respective pixels to generate an image on the flat-panel display system 10.

The flat-panel display system 10 also includes a plurality of memristive pixel cells 18 that are controlled by the scan and hold circuits 14 and 16. For example, each of the memristive pixel cells 18 can be associated with a respective pixel of the flat-panel display system 10. Each of the memristive pixel cells 18 can include a memristive device that can be controlled by the scan and hold circuits 14 and 16. As described herein, the term “memristive device” can be defined as a memristor, such that “memristive pixel cell” can be defined as a pixel cell that includes a memristor.

For example, the flat-panel display system 10 can be configured as a liquid crystal display (LCD), such that the flat-panel display system 10 can also include a backlight (not shown). As a result, the memristive devices can be configured to control respective liquid crystal (LC) elements for generating the image. As an example, the memristive device of each of the memristive pixel cells 18 can be dynamically controlled to provide a corresponding voltage across the respective LC element for controlling the respective pixel of the image. As another example, the memristive devices can be utilized in other types of display technologies, such as organic light-emitting diodes (OLED), such as to control current flowing to each individual pixel of an active matrix OLED display.

The use of a memristive device in each of the memristive pixel cells 18, as opposed to a silicon-based semiconductor device (e.g., thin film transistor (TFT) devices), can result in a variety of benefits of implementing the flat-panel display system 10, as opposed to typical display systems. As an example, the flat-panel display system 10 can be fabricated at substantially lower temperatures (e.g., room temperature or less), as opposed to higher fabrication temperatures that may be required for silicon-based semiconductor devices. Therefore, the flat-panel display system 10 can be implemented in flexible display devices. As another example, the memristive devices in the flat-panel display system 10 can be fabricated in a less complex manner than conventional TFT devices, which can thus reduce manufacturing costs and increase yield in a fabrication process. As yet another example, the memristive devices of the flat-panel display system 10 can exhibit more rapid switching time (e.g., sub-nanosecond switching) than conventional TFT devices, such that the flat-panel display system 10 can have a greater pixel response time than typical flat-panel displays. Furthermore, the memristive devices include an inherent non-volatile memory function, such that the power consumption of the flat-panel display system 10 can be substantially less than typical display systems.

FIG. 2 illustrates another example of a flat-panel display system 50. Similar to as described previously in the example of FIG. 1, the flat panel display system 50 can be incorporated in a display device of a variety of consumer electronic products, such as televisions, laptop and tablet computers, portable electronic reading devices, digital picture frames, price-labels, flexible display devices, and a variety of other electronic devices.

The flat-panel display system 50 includes a display controller 52. In the example of FIG. 2, the display controller 52 receives a signal DATA, such as provided from a processor (not shown), that can correspond to an image to be displayed by the flat-panel display system 50. The display controller 52 is thus configured to generate image data IMG that can correspond to peripheral commands associated with the image to be displayed by the flat-panel display system 50. Alternatively, the display controller 52 can be configured as a processor that generates the image data IMG directly. In the example of FIG. 2, the display controller 12 provides the image data IMG to a scan circuit 54 and a hold circuit 56.

The scan circuit 54 corresponds to a peripheral circuit configured to control a plurality X of scan lines, where X is a positive integer, that each corresponds to a row of an array of pixels associated with the flat-panel display system 50. In the example of FIG. 2, the scan lines are demonstrated as S₁ through S_{X}. Similarly, the hold circuit 56 corresponds to a peripheral circuit configured to control a plurality Y of hold lines, where Y is a positive integer, that each corresponds to a column of the array of pixels associated with the flat-panel display system 50. In the example of FIG. 2, the hold lines are demonstrated as H₁ through H_{Y}. Therefore, the scan and hold circuits 54 and 56 are configured to activate and deactivate the pixels on the flat-panel display system 50 via the scan and hold lines S and H to generate the image.

The flat-panel display system 50 also includes a plurality of memristive pixel cells 58. Each of the memristive pixel cells 58 are coupled to a respective one of the scan lines S and a respective one of the hold lines H. Therefore, each of the memristive pixel cells 58 can be associated with a respective pixel of the flat-panel display system 50. Each of the memristive pixel cells 58 can include a memristive device having a conducting channel that can be opened and closed by the scan and hold circuits 54 and 56 via the scan and hold lines S and H for activation and deactivation of a respective LC element.

For example, the conducting channel of a respecitve memristive device can be opened based on the scan circuit 54 applying a first voltage to a given scan line S and the hold circuit 56 applying a second voltage to a given hold line H, such that the relative voltage between the respective scan and hold lines S and H has a first polarity. As a result, the pixel associated with the respective memristive pixel cell 58 can be activated and deactivated in response to opening the conducting channel of the memristive device to control a voltage across the respective LC element for controlling the respective pixel of the image. As another example, the conducting channel of the respecitve memristive device can be closed based on the scan circuit 54 applying a third voltage to the given scan line S and the hold circuit 56 applying the fourth voltage to a given hold line H, such that the relative voltage between the respective scan and hold lines S and H has a second polarity that is opposite the first polarity. As a result, the state of the LC element can be substantially maintained while the conducting channel of the respective memristive device is closed.

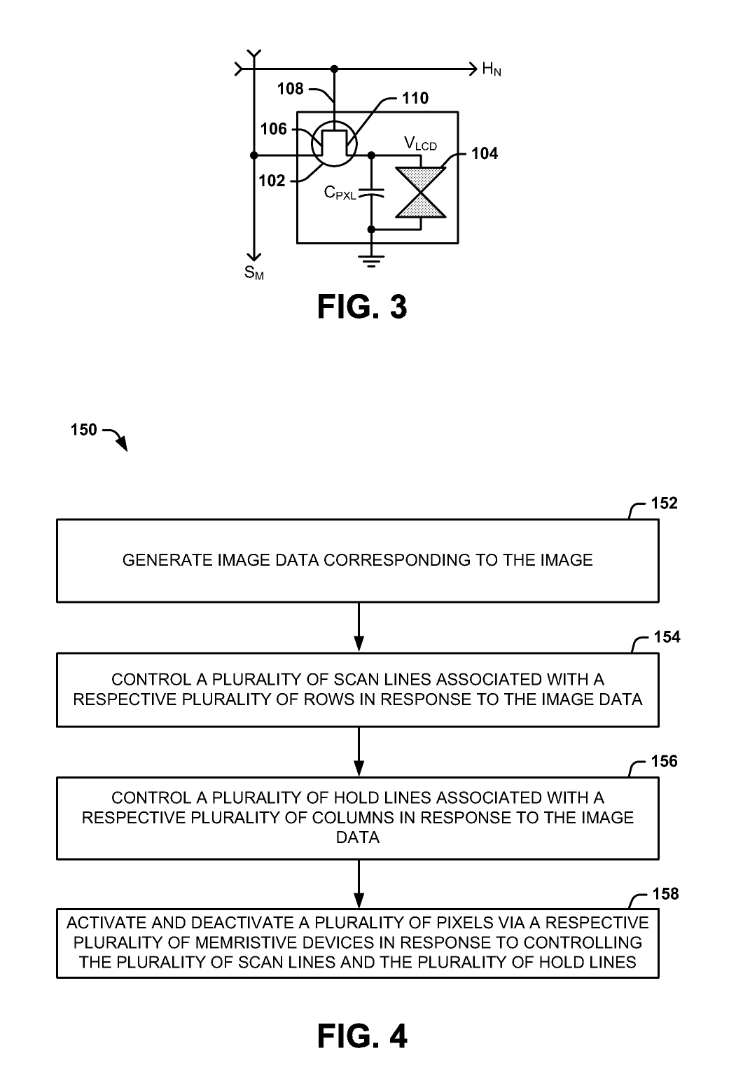

FIG. 3 illustrates an example of a memristive pixel cell 100. The memristive pixel cell 100 can correspond to one of the memristive pixel cells 58 in the example of FIG. 2. Therefore, reference can be made to the example of FIG. 2 in the following description of the example of FIG. 3 for additional context.

The memristive pixel cell 100 includes a memristive device 102, a capacitor C_{PXL}, and an LC element 104. In the example of FIG. 3, the memristive device 102 is arranged as a three-terminal memristive device 102 that is configured as a switch. The memristive device 102 includes a scan terminal 106 that is coupled to a given one of the scan lines S, demonstrated as S_{M} in the example of FIG. 3. Similarly, the memristive device 102 includes a hold terminal 108 that is coupled to a given one of the hold lines H, demonstrated as H_{N} in the example of FIG. 3. The memristive device 102 further includes a third terminal 110 that is coupled to both the capacitor C_{PXL} and the LC element 104, which are coupled in parallel between the third terminal 110 and a low voltage rail, demonstrated in the example of FIG. 3 as ground.

In response to a voltage potential of a first polarity between the scan terminal 106 and the hold terminal 108 of the memristive device 102, a conducting channel of the memristive device 102 can be opened according to the applied voltage potential. For example, the first polarity can be a voltage on the hold terminal 108 provided via the hold line H_{N} that is greater than a voltage on the scan terminal 106 provided via the scan line S_{M}. As a result, a resistance between the scan terminal 106 and the third terminal 110 changes (i.e., decreases) via a memristive mechanism (e.g., oxygen vacancy movement) to open the conducting channel between the scan terminal 106 and the third terminal 110 based on the voltage potential of the first polarity between the scan terminal 106 and the hold terminal 108 of the memristive device 102. Therefore, current flows from the scan line S_{M} to charge the capacitor C_{PXL} and generate a voltage V_{LCD} across the LC element 104. Accordingly, the polarization of the LC element 104 can be controlled to activate the respective pixel based on the voltage V_{LCD} across the LC element 104.

In response to the voltage potential of a second polarity (different from the first polarity) between the scan terminal 106 and the hold terminal 108 of the memristive device 102, the conducting channel of the memristive device 102 can be closed. For example, the second polarity can be a voltage on the hold terminal 108 provided via the hold line H_{N} that is less than a voltage on the scan terminal 106 provided via the scan line S_{M}. As a result, the resistance between the scan terminal 106 and the third terminal 110 changes (i.e., increases) to close the conducting channel (i.e., shutoff) between the scan terminal 106 and the third terminal 110 via the memristive mechanism. Therefore, the charge stored in the capacitor C_{PXL} can be substantially maintained, such that the voltage V_{LCD} across the LC element 104 remains approximately constant. Therefore, the LC element 104 can remain activated to maintain activation of the respective pixel.

To deactivate the respective pixel associated with the memristive pixel cell 100, the conducting channel of the memristive device 102 can be opened again, such as in response to the voltage potential of the first polarity between the scan terminal 106 and the hold terminal 108 of the memristive device 102. However, the voltage potential at the scan terminal 106 can be set to a low voltage potential (e.g., ground). Therefore, upon the conducting channel of the memristive device 102 being opened, the charge stored in the capacitor C_{PXL} can be discharged to the low voltage at the scan terminal 106 (e.g., ground), thus reducing the voltage V_{LCD} across the LC element 104 to less than a critical magnitude. Accordingly, the LC element 104 deactivates, thus deactivating the respective pixel associated with the memristive pixel cell 100. Therefore, upon the capacitor C_{PXL} being discharged by a sufficient amount for deactivation of the LC element 104, the conducting channel of the memristive device 102 can then be closed, such as based on applying the voltage potential of the second polarity between the scan terminal 106 and the hold terminal 108 of the memristive device 102.

The example of FIG. 3 thus demonstrates a manner in which a pixel cell of a flat-panel display can incorporate a memristive device as a replacement for a semiconductor device (e.g., silicon-based) configured as an addressing element for the flat-panel display. The more simple fabrication process of the memristive device 102 of the memristive pixel cells 58 can thus result in a more cost effective fabrication process, with such fabrication process being capable of implementation at low temperatures to allow manufacture of flexible display devices. Additionally, the activation and deactivation of the pixels associated with the memristive pixel cells 58 can be performed more quickly and with less power consumption than typical TFT pixel cells. Furthermore, based on the flexible design and process capability of the memristive devices 102 associated with the memristive pixel cells 58 of the flat-panel display system 50, it is also possible to integrate logic processing, memory, and additional addressing functions using additional memristive devices of the same material platform, such as likewise incorporating a variety of non-silicon-based semiconductor materials, into the flat-panel display system 50 and associated device.

It is to be understood that the flat-panel display system 50 and the memristive pixel cell 100 are not intended to be limited to the examples of FIGS. 2 and 3, respectively. As an example, the memristive pixel cells 58 in the example of FIG. 2 can be addressed in a variety of other manners than a single scan circuit 54 and a single hold circuit 56. In addition, the memristive device 102 is not intended to be limited to a three-terminal device, but could instead be implemented as a two-terminal memristive switching device. Furthermore, the memristive device 102 can be controlled based on other biasing schemes. Therefore, the flat-panel display system 50 and the memristive pixel cell 100 can be configured in a variety of different ways.

In view of the foregoing structural and functional features described above, an example method will be better appreciated with reference to FIG. 4. While, for purposes of simplicity of explanation, the method of FIG. 4 is shown and described as executing serially, it is to be understood and appreciated that the method is not limited by the illustrated order, as parts of the method could occur in different orders and/or concurrently from that shown and described herein.

FIG. 4 illustrates an example of a method 150 for generating an image on a flat-panel display. At 152, image data (e.g., the signal IMG) corresponding to the image is generated (e.g., by the display controller 12). At 154, a plurality of scan lines (e.g., the scan lines S₁ through S_{X}) associated with a respective plurality of rows are controlled (e.g., by the scan circuit 14) in response to the image data. At 156, a plurality of hold lines (e.g., the hold lines H₁ through H_{Y}) associated with a respective plurality of columns are controlled (e.g., by the hold circuit 16) in response to the image data. At 158, a plurality of pixels are activated and deactivated via a respective plurality of memristive devices (e.g., the memristive device 102) in response to controlling the plurality of scan lines and the plurality of hold lines (e.g., based on the arrangement of the memristive pixel cell 100).

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A flat-panel display system comprising:
a display controller to generate image data; and
a plurality of memristive pixel cells arranged in a plurality of rows and in a plurality of columns, each of the plurality of memristive pixel cells comprising a memristive device to control a respective pixel associated with the flat panel display based on the image data.

2. The system of claim 1, further comprising:
a scan circuit to control a plurality of scan lines associated with the respective plurality of rows in response to the image data; and
a hold circuit to control a plurality of hold lines associated with the respective plurality of columns in response to the image data.

3. The system of claim 2, wherein each of the plurality of memristive pixel cells is to control the respective pixel associated with the flat panel display based on the control of a respective one of the plurality of scan lines and a respective one of the hold lines.

4. The system of claim 2, wherein the memristive device associated with each of the plurality of memristive pixel cells comprises a three-terminal memristive device comprising a control terminal coupled to a respective one of the plurality of scan lines, an input terminal coupled to a respective one of the plurality of hold lines, and a third terminal coupled to a liquid crystal (LC) element

5. The system of claim 4, wherein a conducting channel associated with the memristive device is opened in response to a first voltage potential between the control terminal and the input terminal having a first polarity and is closed in response to a second voltage potential between the control terminal and the input terminal having a second polarity that is opposite the first polarity to control a voltage across the LC element to control the respective pixel based on the image data.

6. The system of claim 1, wherein each of the plurality of memristive pixel cells comprises a capacitor and a liquid crystal (LC) element coupled to the memristive device, the memristive device being to generate a voltage across the capacitor and the LC element to activate the respective pixel in response to controlling the memristive device.

7. A display device comprising the flat panel display system of claim 1.

8. A method for generating an image on a flat-panel display, the method comprising:
generating image data corresponding to the image;
controlling a plurality of scan lines associated with a respective plurality of rows in response to the image data;
controlling a plurality of hold lines associated with a respective plurality of columns in response to the image data; and
activating and deactivating a plurality of pixels via a respective plurality of memristive devices in response to controlling the plurality of scan lines and the plurality of hold lines.

9. The method of claim 8, wherein activating and deactivating the plurality of pixels comprises activating and deactivating a plurality of pixels via a respective plurality of three-terminal memristive devices each comprising a control terminal coupled to a respective one of the plurality of scan lines and an input terminal coupled to a respective one of the plurality of hold lines.

10. The method of claim 9, wherein activating and deactivating the plurality of pixels comprises:
opening conducting channels associated with the respective plurality of memristive devices based on generating a first relative voltage having a first polarity between the control terminal and the input terminal in response to controlling the plurality of scan lines and the plurality of hold lines; and
closing the conducting channels associated with the respective plurality of memristive devices based on generating a second relative voltage having a second polarity that is opposite the first polarity between the control terminal and the input terminal in response to controlling the plurality of scan lines and the plurality of hold lines.

11. The method of claim 8, wherein activating and deactivating the plurality of pixels comprises:
generating a voltage across a capacitor and a liquid crystal (LC) element coupled to the memristive device in response to the memristive device being controlled to activate a respective one of the plurality of pixels; and
discharging the capacitor in response to the memristive device being controlled to deactivate the respective one of the plurality of pixels.

12. A flat-panel display system comprising:
a display controller to generate image data;
a scan circuit to control a plurality of scan lines associated with a respective plurality of rows in response to the image data; and
a hold circuit to control a plurality of hold lines associated with a respective plurality of columns in response to the image data
a plurality of memristive pixel cells that are each coupled to a respective one of the plurality of scan lines and a respective one of the plurality of hold lines, each of the plurality of memristive pixel cells comprising a three-terminal memristive device to control a respective pixel associated with the flat panel display based on the image data.

13. The system of claim 12, wherein the three-terminal memristive device comprises a control terminal coupled to a respective one of the plurality of scan lines and an input terminal coupled to a respective one of the plurality of hold lines.

14. The system of claim 13, wherein a conducting channel associated with the three-terminal memristive device is opened in response to a first voltage potential between the control terminal and the input terminal having a first polarity and is closed in response to a second voltage potential between the control terminal and the input terminal having a second polarity that is opposite the first polarity to control the respective pixel based on the image data

15. The system of claim 12, wherein each of the plurality of memristive pixel cells comprises a capacitor and a liquid crystal (LC) element coupled to the three-terminal memristive device, the three-terminal memristive device being to generate a voltage across the LC element to activate the respective pixel in response to the three-terminal memristive device being controlled.
